(19) United States
(12) Patent Application Publication
(10) Pub. No.: US 2010/0249013 A1
(43) Pub. Date: Sep. 30, 2010

(54) ENCAPSULATED ACTIVE INGREDIENTS FOR CLEANING APPLICATIONS

(76) Inventors: Molly I-Chin Busby, Midland, MI (US); Karen A. Coppens, Midland, MI (US); Mark J. Hall, Midland, MI (US)

Correspondence Address: The Dow Chemical Company, P.O. BOX 1967, Midland, MI, 48641, US

(21) Appl. No.: 12/675,594

(22) PCT Filed: Aug. 26, 2008
(86) PCT No.: PCT/US08/74284

§ 371 Date: Feb. 26, 2010

Related U.S. Application Data
(60) Provisional application No. 60/968,506, filed on Aug. 28, 2007.

(51) Int. Cl. C11D 17/00

(52) U.S. Cl. 510/438

(57) ABSTRACT

Described are encapsulated time-release cleaning agents, comprising active agents that, when combined with an aqueous phase, have slight delay release, moderate delay release, and/or extended delay release. The invention also relates to the manufacture and use of such compositions.

### FIELD

The invention relates to encapsulated controlled-release cleaning agents and their manufacture and use.

### BACKGROUND

Effective detergent compositions e.g., laundry formulations, typically include a number of different active ingredients including surfactant, water softener, bleach, enzyme, and fragrance. Undesirable interactions between these ingredients can adversely affect product performance. Such interactions include, but are not limited to, interactions in a dry state (which can affect, e.g., shelf life of the product) and interactions in a wet state (which can affect, e.g., performance of one or more actives). Thus, it is often not possible to achieve the optimum cleaning results that would be expected from the individual ingredients. Adding the separate ingredients at different times during the wash cycle can help to avoid this problem, but it not convenient for consumers.

Thus, what is needed are encapsulated or other controlled release cleaning agents for incorporation into detergent compositions.

### SUMMARY

In one embodiment, the present invention provides cleaning compositions comprising at least two particles, each particle comprising at least one active agent, wherein the at least two particles are adapted to release active agent at different delay release times when the cleaning composition is combined with an aqueous phase, and said particles being encapsulated with water soluble cellulose coating.

### BRIEF DESCRIPTIONS OF THE DRAWINGS

FIG. 1 shows detergency of the actives of Examples 1-5 against motor oil.

FIG. 2 shows detergency of the actives of Examples 1-5 against dust sebum.

FIG. 3 shows detergency of the actives of Examples 1-5 against grass stains.

FIG. 4 shows detergency of the actives of Examples 1-5 against coffee stains.

FIG. 5 shows detergency of selected compositions against grass stains.

### DETAILED DESCRIPTION

The present invention is directed to encapsulated active ingredients for cleaning applications. Making each active available at an appropriate time in the wash cycle can reduce or eliminate problems such as deleterious interaction of actives in the solid or liquid states. This controlled release can be accomplished by providing each active ingredient after certain specified delay periods after the composition is combined with an aqueous phase. For example, this can be done by coating or encapsulating the active in a water soluble polymer which dissolves over time in the wash water releasing the active. By coating the actives with controlled release materials, the timing of their availability in the cleaning process can be controlled so that antagonistic actives will be present at different times in the cleaning cycle and, therefore, not interfere with each other. In addition to cleaners, the invention may be useful in the agricultural field, air care, and water treatment products.

In a preferred embodiment, the invention is directed to laundry cleaning compositions comprising active ingredients that are encapsulated so as to release active ingredients at different times. The composition may be extruded and formed into pellets or other shapes. Such shapes may be granular (e.g., to be measured out with a cup or other device), or may comprise pre-measured amounts for easy use by the consumer (e.g., a specified number of blocks per load). As used herein, the term “particle” can refer to a solid, a liquid, or a combination of the two, e.g., an encapsulated liquid. While the term is not limited by size, the term “particle” will generally refer to components having a size of less than about 2 mm, 1 mm or 0.5 mm. It will generally refer to components having a size greater than about 0.01 mm or 0.05 mm. Moreover, the term “particle” does not depend on the environment in which the component is situated. Thus, particles may be free flowing, or may be bound, e.g., in an extrudate or compressed cake or tablet.

The present invention provides a cleaning composition that, when combined with an aqueous phase, is capable of releasing active ingredients into the aqueous phase at different times. Without limiting the invention in any way, it is convenient to refer to slight delay, moderate delay, and extended delay. The term “slight delay,” as used herein, conveniently refers to a brief delay time prior to release of active. In embodiments, brief delay can refer to delay times of about 2 minutes or less, e.g., about 1 minute, about 30 seconds, about 15 seconds, or ranges defined by these times, e.g, about 15 seconds to 2 minutes. The term “moderate delay” should be understood as referring to a period of time well into the relevant cycle (e.g., wash cycle), but far enough from the end of the cycle that the active in question has significant time in contact with the relevant material (e.g., items being washed). In embodiments, moderate delay can refer to delay times of about 3 minutes or more, e.g., 4, 5, 6 or 7 minutes, or ranges defined by these times, e.g., about 3-7 minutes. The term “extended delay” should be understood to refer to times longer than moderate delay, yet less than the length of the relevant cycle (e.g., wash cycle). In embodiments, extended delay can refer to delay times of about 8 minutes or greater, e.g., 10, 12 or 14 minutes, or ranges defined by these times, e.g., about 8-14 minutes.

In a preferred embodiment, active ingredients are provided with delayed release coatings, such that release of the coated active is delayed for a predetermined amount of time after combining with an aqueous phase. In a preferred embodiment, the present invention includes two or more coated active ingredients with different delay periods.

It should be understood that the term “delay period” generally refers to the time at which the active is released. The term can refer to immediate and rapid release once the appropriate time has been reached. It can also refer to the time at which a certain percentage of active has been released. In this regard, it should be understood that release of actives as described herein may be rapid, slow, or somewhere in between, and that the present invention covers all of these embodiments. In general, release of active is not an instantaneous process. Rather, it is more often a continuous process that may begin slowly, and generally accelerates for a time, eventually slowing down, and ending when all active is released. Thus, the term “delay period” does not necessarily mean that no active is released until the specified time has been reached, or that 100% of the active is released when the specified time is reached (though these embodiments are included in the present invention). As used herein, references to delay periods or release times refer to times by which about 30%, 50%, 60%, 75% or 90% of the active is released into the medium. Put another way, references to delay periods or release times refer to times after which no more than about 10%, 25%, 40%, 50% or 70% of the active is released into the medium.

The delay period for each active ingredient may be selected based on the needs of each particular application. General guidelines for many applications are given herein, but the invention is not limited to these general guidelines.

As a general matter, one aspect of the present invention includes reducing potential hazards that might be associated with handling detergent compositions. In this aspect, there is provided a method of reducing exposure to skin and/or reducing inhalation, of detergent compositions. This may preferably be accomplished by providing a time-release coating on one or more components, which time release coating provides a slight delay in release. A slight delay in release may help to reduce or eliminate exposure of the skin to actives in the detergent composition.

Actives provided with a slight delay can be any active, preferably an active which is desired to be released quickly, but for which contact with skin and/or inhalation is desired to be reduced or minimized. Where a detergent composition comprises one or more such actives, one, some, or all may be provided with a slight delayed release coating. Some actives for which a slight delay may be advantageously provided include surfactant, bleach activator, alkanolamine, metal carbonates, metal silicates and chelating agents. In this aspect, any slight delay should be useful to reduce exposure to an active. In this regard, as used herein, the term “slight delay” means any delay that is slight, and that provides sufficient delay to reduce or eliminate exposure of skin to active when, e.g., a consumer is using and/or handling the product. In a preferred aspect, all or most potentially hazardous actives are provided with at least a slight delay in release. In an aspect, a slight delay can be, for example, less than, or about, the following times: 2 minutes, 1 minute, 30 seconds, or 15 seconds, or within ranges of these times.

Certain actives—including, but not limited to, surfactants, chelating agents, alkanolamine and carbonate or silicates—are generally desired to be released immediately, or after a slight delay, after combining with an aqueous phase, e.g., wash water. For other ingredients—including, but not limited to, bleaching agents and fabric softeners—a lengthier delay may be useful. In order to maximize time during which articles are exposed to cleaning components, it is generally desired to have surfactants release after a slight delay. In an aspect, surfactant release time may be about 2 minutes, more preferably about 1 minute, more preferably about 30 seconds.

When concentrated bleaching agents are exposed to articles, there can be a detrimental impact on the articles, such as excessive removal or degradation in coloring. This can be reduced or eliminated by providing bleaching agent in delayed release form. Bleaching agents may be released into the aqueous phase at any time advantageous for a particular application. In an aspect, a delayed release for bleaching agent preferably provides sufficient time to permit a washing machine tub to substantially fill prior to release. Preferably, bleaching agent will be provided a moderate delay of at least about 3 minutes after combining with the aqueous phase. More preferable release times include about 4, 5, 6, or 7 minutes. When two or more bleaching agents are used, they are preferably released at about the same time, but may release at different times. Bleach activators, are generally milder than bleaching agents, and when present, can be released at any appropriate time for a particular application. In an aspect, bleach activator can be released immediately, more preferably after a slight delay. If desired, bleach activator can be released slightly before, after, or at about the same time, as bleaching agent. Thus, when a bleaching agent has moderate delayed release, a bleach activator may be provided with slight or moderate delayed release. Because bleaching agents may react with bleach activators even in the dry state, it is preferred that they be kept separate prior to combining with the aqueous phase. That is, the bleach and bleach activator may be provided in separate beads or granules, such that a time release coating on at least one of them will prevent or reduce, or minimize interaction prior to release in the aqueous phase. In a preferred aspect, time release coating associated with bleaching agent serves to separate the two components. Bleach and bleach activator may also be provided in the same bead or granule, preferably with a barrier in between to prevent or reduce interaction prior to combining with an aqueous phase. Such a barrier can be any barrier suitable to keep the components separate. In preferred aspects, a delay release coat, e.g., a slight delay release coat or a moderate delay release coat, on either or both actives, can serve as barrier to separate bleach from bleach activator.

In general, enzymes are desired to be released immediately, or after a slight delay, preferably after a slight delay. Because enzymes are generally cationically stabilized, it is preferable to prevent or reduce interaction with anionic ingredients. Such interaction can, for example, reduce shelf-life of a detergent product. In a preferred aspect, therefore, enzymes are maintained separate from anionic components, such as anionic surfactants. In a preferred aspect, this can be brought about by providing a barrier between enzyme and anionic components, e.g., by coating or encapsulating one or both types of ingredients. Such a barrier can be any barrier suitable to keep the components separate. In preferred aspects, a delay release coat, e.g., a slight delay release coat or a moderate delay release coat, on either or both actives, can serve as barrier to separate enzyme from anionic active.

Fragrances are also contemplated for use within the present invention. If fragrance or perfume releases too early, then it is possible that a large proportion might simply wash away. It is preferable, therefore, for perfume to be released late in the wash cycle, preferably after an extended delay. Fragrance may be released at any appropriate time, preferably at or later than about 8, 10, 12 or 14 minutes.

It is also contemplated for use in the present invention to include a polymer or other binding substance that can serve to provide targeted delivery of, e.g., fragrance, brightener or other active. The binding substance would act to bind the active to the material being treated, e.g., textiles or laundry. Targeted delivery is discussed in U.S. Pat. No. 7,053,034, which is incorporated by reference herein in its entirety. In a preferred embodiment, the actives provided with a delay release coating are combined with a water soluble extrusion material, preferably a water soluble hot melt extrusion material, and then extruded to form a predetermined shape. Any shape or configuration for the extrudate may be used, preferably bead, spheroids, pellets, sheets or blocks. Blocks may be of any desirable shape, including spheres, ellipsoids, cylinders, prisms, or rectangular blocks.

Any type of coating equipment may be used. Equipment such as used in the pharmaceutical arts is preferred, and preferably includes fluidized bed coating equipment, conventional coating pans, or perforated coating pans. In a fluidized bed system, the material to be coated is typically fluidized by an upward flow of air. Coating solutions are generally applied by spray nozzles typically located either at the top or bottom of the air column. Fluidized bed coaters are available from a variety of manufacturers, including Glatt, Aeromatic-Fielder, and Vector/Freund. In a Wurster (bottom spray) fluid bed coater, for example, a flow pattern is formed by a partition and an orifice plate. In the vicinity of spray nozzles at the bottom of the chamber, air is forced upward from the bottom center of the generally cylindrical device, and a generally cylindrical partition within the device chamber causes fluidization and upward travel of the cores within the partition. When the cores exit through the top of the partition, they enter an expansion zone where air velocity decreases, and the cores drop outside the partition. The cores descend, then continue cycling through the device. See, McGinity, James W., ed., Aqueous Polymeric Coatings for Pharmaceutical Dosage Forms, Marcel Dekker, Inc., New York, 1997; and Jones et al., “Coating of Multiparticulates Using Molten Materials,” in Multiparticulate Oral Drug Delivery, Ghebre-Sellassie, ed., pp. 113-142 (Marcel Dekker, 1994); (incorporated herein by reference in their entireties).

A typical conventional coating pan generally comprises a round metal pan mounted at an angle on a stand, so that the mouth of the pan is angled above horizontal, but not straight up. As the pan rotates, a coating solution is applied to the material in the pan, generally by spray or ladle. A perforated pan system generally has the pan (or drum) mounted horizontally, with the pan being partially or completely perforated to allow flow of air. The coating solution is generally sprayed onto the material to be coated with nozzles typically located inside the drum. Typical perforated pan coating equipment includes Accela-Cota, Hi-Coater, Driacoater, and Glatt coaters. It is believed that the most important operating conditions for sample preparation are spray rate and temperature, and that it is important to achieve a balance between the two. If the spray rate is too fast, it can overwet the substrate. In that case, the substrate may not dry in the available time, resulting in a tacky coating. If the spray rate is too slow, it can give a rough surface and/or may not form a continuous film. With regard to temperature, if the temperature is too hot, the spray may dry out too soon, and a continuous coating might not be achieved. If the temperature is too low, it can result in a tacky coating. The time-release coatings may include any time-release coating such as used in pharmaceutical applications. Without limiting the present invention, the coatings are generally polymers, often cellulose or cellulose derivatives.

Cellulosic polymers are high molecular weight polymers with repeating units of the basic sugar structure. The hydroxyl groups on the polymer units can be derivatized to provide a wide variety of materials. Methyl cellulose and ethylcellulose are made by capping some of the hydroxyl groups on the cellulose polymer with methyl groups or ethyl groups respectively. This reduces the level of hydrogen bonding compared to cellulose and somewhat lessens the hydrophilic nature of the polymer. Instead of capping the hydroxyl groups, they can be reacted with ethylene oxide or propylene oxide to give hydroxyethyl or hydroxypropyl cellulose. Finally, both alkoxylation and capping can be used to make polymers like hydroxypropyl methylcellulose. Cellulosic polymers are of interest both for their variety of useful properties and their bio-origin making them more environmentally friendly. The variety of cellulosic polymers and consequently their properties make them valuable for delayed release and controlled release applications. Without limitation, some water-soluble cellulosic polymers that can be used in the present invention include sodium carboxymethylcellulose (CMC), hydroxyethylcellulose (HEC), hydroxypropyl cellulose (HPC), hydroxypropylmethyl cellulose (hypromellose, or HPMC), and methylcellulose (MC), as well as combinations of two or more thereof. Without limitation, some water-insoluble cellulosic polymers that can be used in the present invention include cellulose, ethylcellulose (EC) and hydroxypropyl cellulose (HPC), as well as combinations of two or more thereof.

Time release coatings, including coatings comprising cellulose and/or cellulose derivatives, are generally one of two types. One type of coating involves a water-insoluble material and a water-soluble pore forming material. The component not soluble in water may be any component suitable for this purpose, and will generally comprise a derivatized cellulose, e.g., ethylcellulose. The component soluble in water will generally be present in particulate form, and will generally comprise a low molecular weight polymer (e.g., polyethylene glycol), a carbohydrate such as a polysaccharide (e.g., lactose), or other suitable material (e.g., sodium chloride or other salt). By “water-insoluble” is meant that the material will retain water-barrier properties for a period of time longer than it takes for the water-soluble material to dissolve in an aqueous medium. In one embodiment of this type of coating, dissolution of the pore-forming material controls release of the active into the aqueous medium to a greater degree than does dissolution or degradation of the water-insoluble material. Such a coating may be applied, for example, by dissolving the insoluble material in a solvent, and combing with particulate water-soluble material. A solvent should be chosen that does not dissolve the water-soluble material. A plasticizer may be added to increase resiliency of the coating. The coating material is then coated onto the component comprising active ingredient. Any type of coating apparatus may be used, including, for example, those discussed above.

When the coated material is added to an aqueous medium, the water-soluble pore forming material dissolves, thereby forming pores in the coat through which water can enter. The water dissolves material within the particle, which can then be released through the pores, and into the external aqueous medium. By controlling the nature and amount of pore forming material, one can control how long it takes for an active ingredient in a particle to be released. In another type of coating, the coating is a polymer that is capable of slowly dissolving or degrading in an aqueous medium, e.g., during a laundry cycle. The rate of dissolution or degradation can be controlled by controlling the molecular weight of the polymer. When a modified cellulose is used, then the rate of dissolution or degradation can also be controlled by controlling the nature or degree of substituents. A plasticizer may be included to improve the resilience of coating materials e.g., if they are too brittle.

As an example of this type of coating, coating compositions comprise a polymer primarily responsible for controlling time release. In a preferred aspect, the polymer comprises a cellulose derivative, e.g., hydroxypropyl methylcellulose (HPMC), methylcellulose (MC), ethylcellulose (EC), preferably HPMC. The molecular weight and degree of substitution of the polymer can have an affect on release rate. For example, as a general rule, a lower polymer molecular weight leads to more rapid release when other parameters (e.g., degree of substitution, total coating amount, etc.) are kept constant. As a general rule, a thicker polymer coat leads to less rapid release when other parameters (e.g., degree of substitution, polymer molecular weight, etc.) are kept constant.

A plasticizer may be included in time release coatings. Any plasticizer appropriate for a given time release polymer may be used, preferably a plasticizer not detrimental to other components of the selected composition. One suitable plasticizer is polyethylene glycol (PEG), preferably PEG 400.

Granular materials may be directly coated. Optionally, two or more actives may be combined and granulated together, preferably by mixing prior to coating. Optionally, two or more dry actives are simply mixed then coated. Actives may also be wet or dry granulated together and optionally sieved prior to coating. When an active is a liquid at ambient temperatures, it is preferred to coat the active on a dry carrier material prior to applying a delay coating. Optionally, a liquid active can be encapsulated, e.g., as a liquid surrounded by a solid time-release membrane. In some embodiments, the carrier material can be non-active, e.g., a non-pareil or lactose bead. In some embodiments, the carrier material can be in the form of granules comprising, consisting essentially of, or consisting of, one or more actives.

Time release properties of the coatings can be controlled in any manner. One way to control release is by controlling the thickness of the coat. It has been shown that for a selected coating material, the polymer level (i.e., the coating thickness) has a major affect on rate of release of the coated active ingredient. See, e.g., Ford et al., IJP, 24:327-338 and 339-350, which are incorporated by reference herein in their entireties.

Any active ingredients used in detergents may be used in the present invention. The particular release times chosen will generally depend on the combination of ingredients used, and can vary, even for a specific active, depending on the particular application that the cleaning composition is designed for. Some commonly used classes of ingredients include surfactants, chelating agents, (monoethanolamine), (sodium carbonate), bleach, bleach activator, enzyme and fabric softener.

Non-active ingredients include carrier materials, coloring agents, and perfume. For certain active ingredients, e.g., those that are liquid at room temperature, it may be advantageous to first combine the active with a carrier prior to coating. The carrier itself can comprise a non-active ingredient, e.g., lactose non-pareils.

The surfactant, can be an anionic surfactant, cationic surfactant, amphoteric surfactant, nonionic surfactant, or mixtures of two or more surfactants. Preferred surfactants mixtures include one or more anionic surfactant, optionally combined with at last one amphoteric or non-ionic surfactant. Any anionic surfactant can be used in the present invention. Anionic surfactants can be used singly, or in combination. Some exemplary suitable anionic surfactants include alkyl benzene sulfonates, alkyl sulfate ethoxylates, alkyl ether sulfate, fatty alcohol sulfates, alpha-olefinsulfonates, alkyl alkoxy carboxylates, diphenyl sulfonates, sodium laurate, sodium myristate, sodium palmitate, sodium stearate, and combinations of two or more thereof. Any nonionic or amphoteric surfactant can be used in the present invention. Some exemplary suitable nonionic surfactants include alcohol ethoxylates, polypropylene glycol, polypropylene esters, alkylpolyglocosides, sorbitol esters, monoalkanolamines, dialkanolamines, trialkanolamines, polyoxyethylenealkylethers, polyhydric alcohol fatty acid partial esters, polyoxyethylenealkylphenylethers, polyoxyethylenized castor oil, fatty acid diethanolamide, polyoxyethylenealkylamines, polyoxyethylenepolyhydric alcohol fatty acid partial esters, polyglycerin fatty acid esters, polyoxyethylenepolystyrylphenylether, polyoxyethylene fatty acid esters, polyoxyethylenepolyoxypropyleneglycol, polyoxyethylenepolyoxypropylenealkylethers, triethanolamine fatty acid partial esters, trialkylamine oxides and combinations of two or more thereof. Some exemplary amphoteric surfactants include sulfobetaines, glycinates, propionates, N,N-dimethyl-N-alkyl-N-carboxymethylammonium betaines, N,N-dialkylaminoalkylene carboxylates, N,N,N-trialkyl-N-sulfoalkyleneammonium betaines, N,N-dialkyl-N,N-bispolyoxyethyleneammonium sulfate betaines, 2-alkyl-1-carboxymethyl-1-hydroxyethylimidazolinium betaines, and mixtures thereof. Cationic surfactants can also be included in compositions of the present invention. Because of their weaker cleaning activity, however, cationic surfactants are not preferred. If included in a composition comprising anionic surfactant, then one surfactant, e.g., cationic surfactant, would preferably be provided with a moderate delay release to reduce interactions between anionic and cationic surfactants. Some exemplary suitable cationic surfactants include quaternary ammonium salts such as primary-tertiary aliphatic amine salts, tetraalkyl ammonium salts, trialkylbenzyl ammonium salts, alkylpyridinium salts, 2-alkyl-1-alkyl-1-hydroxyethylimidazolinium salts, N,N-dialkylmorpholinium salts, polyethylenepolyamine aliphatic amide salts, salts of urea condensates of polyethylenepolyamine aliphatic amides, and quaternary ammonium salts of urea condensates of polyethylenepolyamine aliphatic amides and combinations of two or more thereof.

Any suitable amount of surfactant can be used in the present invention, and can be determined by those of ordinary skill in the art. Preferred amounts of surfactant in compositions of the present invention include from about 2 to about 90 weight %, more preferably about 25 to about 40 weight %, the weight % being based on the total weight of actives in the detergent composition.

Chelating agents may be included in the present invention. Chelating agents are preferably provided with slight delayed release. Any chelating agent can be used. When used, chelating agents include, but are not limited to, EDTA salts, citric acid, NTA, disodium hydroxy ethylimido diacetic acetate, and combinations of two or more thereof.

Any bleaching agent may be used. Some bleaching agents and activators that may find use in the present detergent composition are described in U.S. Pat. Nos. 4,412,934, and 4,483,781, both of which are incorporated herein by reference in their entireties. Suitable bleach compounds include perborates (e.g., sodium perborate), persulfate, percarbonates (e.g., sodium percarbonate), and combinations of two or more thereof. A bleaching agent may also be used in combination with an activator such as, for example, tetra-acetyl-ethylenediamine (TAED), sodium nonanoyloxybenzene sulfonate (SNOBS), diperoxydodecanedioc acid (DPDDA) and the like, and combinations of two or more thereof.

If desired, cleaning compositions of the present invention may include enzymes for any of a variety of laundering purposes, including removal of protein-based, carbohydrate-based, or triglyceride-based stains, for example, and for the prevention of refugee dye transfer, and for fabric restoration. They can be of any suitable origin, such as vegetable, animal, bacterial, fungal and yeast origin. Enzymes that may be used include protease (e.g., Purafect 4000E, Properase 4000E, Esperase, Alcalase, Durazym, Savinase, Maxatase, Maxacal, Properase, Maxapem), amylase, e.g., alpha- and/or beta-amylase (e.g., Purastar ST 6000E, Purastar OxAm 4000E, Purafect Ox Am, Termamyl, Ban, Fungamyl, Duramyl, Natalase), cellulase (e.g., Puradax HA 400E, Carezyme, Celluzyme), lipase (e.g., Amano-P, M1 Lipase, Lipomax, Lipolase and Lipolase Ultra), cutinase (available from. e.g., Novozymes), pectinase (e.g., Pectaway® (Novozymes)), and peroxidase (available from, e.g., Sigma-Aldrich), as well as mixtures and combinations thereof. Other types of enzymes can also be included. Enzymes may be used in any quantity needed for a particular application. Generally, enzymes may be present in an amount from about 0.0001% to about 2% pure enzyme by weight of actives.

Fabric softeners may also be included in compositions and methods of the present invention. In order to increase effectiveness of fabric softener, is it believed that it would preferably be released after an extended delay. Moreover, because fabric softeners are generally cationic in nature, it is preferable to delay release thereof until well after any anionic surfactant is released.

Other active ingredients may also be used in compositions and methods of the present invention, including, but not limited to detergent builders, abrasives, pH regulators, whiteners, brighteners; water softeners; pH regulators, or fillers. Some exemplary detergent builders include borates, phosphates (e.g., trisodium phosphate), polyphosphates, silicates, sodium potassium carbonates, and combinations of two or more thereof. Some exemplary abrasives include sodium carbonate, sodium silicate, and combinations of two or more thereof, which also have pH regulating activity. Some exemplary pH regulators include alkanolamines, carbonates, silicates, phosphates (some of which (e.g., alkanolamines) also have cleaning activity), and combinations of two or more thereof.

In some embodiments, compositions of the present invention may be provided in a form that is extrudable, preferably hot-melt extrudable. By the term “extrudable” is meant that the composition may be processed through extrusion equipment to form an extrudate. To form an extrudable composition, it is generally advantageous to include an extrusion carrier material. A hot-melt extrusion carrier is one that is sufficiently rigid at ambient conditions, but is capable of deformation or forming a semi-liquid state under elevated heat or pressure. If desired, compositions may include a plasticizer, e.g., to render them hot-melt extrudable or to improve properties of the extruded product. In compositions of the present invention, an extrusion carrier material may be part of the time-release coating, or may be added as a separate ingredient. Even where a time release coating comprises an extrusion carrier material, additional extrusion carrier material can be added if desired.

Any carriers suitable for use in extrusion, preferably hot-melt extrusion, may be used. Extrusion carriers are preferably sufficiently water soluble so as to free contained particles rapidly upon combination with an aqueous phase. Alternately, when an extrusion carrier is used, e.g., when the cleaning composition is in the form of an extrudate, or is to be extruded, actives, preferably slight-delayed release actives, can be simply dispersed in the extrusion carriers not in particular form. Preferably, actives (whether or not in the form of particles) will be substantially freed from the extrudate (as opposed to release of actives from particles) in less than 1 minute after combining with an aqueous phase (e.g., wash water), more preferably in less than 30 seconds. In a preferred embodiment, particles will begin to be freed from the extrudate immediately (e.g., in less than 5 seconds) upon contact with an aqueous phase, e.g., wash water.

As disclosed in U.S. Pat. No. 6,488,963 (the disclosure of which is incorporated by reference in its entirety), some suitable hot-melt extrusion carriers include derivatized cellulose, poly(methacrylate) derivative, poly(ethylene-co-vinyl acetate), poly(ethylene), poly(vinyl acetate-co-methacrylic acid), epoxy resins, caprolactones and poly(ethylene oxide). Suitable materials, methods, and equipment for hot melt extrusion are also disclosed in WO 2007/001451 (based on PCT/US2005/040535, claiming priority to U.S. 60/626,400 and 60/681,279, all four of which are incorporated by reference in their entireties).

There are several parameters in the extrusion process that can be adjusted. Some may affect processing, some may affect properties of the final product, and some may be affected by the properties of the composition being extruded. Some are also determined by the type and model of extrusion equipment used. It is believed that these parameters include feed rate, operating temperature, extruder screw RPM, residence time, die configuration, heating zone length and extruder torque and/or pressure.

More generally, it should be understood that properties of a product of the present invention can depend on the specific ingredients and purities thereof. In particular, it should be understood that properties of polymers, including cellulosic polymers, can vary according to several variables. Such variables include, but are not limited to, polymer type and degree of substitution, polymer concentrations, polymer molecular weight, and polymer particle size. Moreover, the shape and size of beads or pellets, as well as particle hardness, can also affect properties of a composition according to the present invention.

In practice, it is generally preferable to produce a product with uniform predictable properties from one batch to another. It is believed that many different combinations of parameters can be employed to obtain any specific set of properties, e.g., time-release properties. Accordingly, it is generally believed advisable to maintain consistency over such parameters as discussed in the preceding paragraph.

### EXAMPLES

### Example 1

### Surfactant Package

Materials comprising the surfactant package were designated to be released after a slight delay in a laundry cycle. A combination of three liquid materials was used as shown in Table 1.

TABLE 1

| Material | Amount |
|---|---|
| TERGITOL 15-S-9 C12-14 secondary alcohol | 82.5% |
| ethoxylate surfactant | |
| disodium hydroxy ethylimido diacetic acetate | 8.75% |
| Monoethanolamine | 8.75% |
| Total | 100 |

These materials were applied to a solid substrate prior to coating with HPMC. Non-pareils (sugar spheres—30-35 mesh) from Paular, were used as the substrate. The liquids were mixed together and sprayed “as-is”, without dilution or addition of other materials. The target was a 10% weight gain of the materials on the non-pareils. The coating conditions are shown in Table 4.

All encapsulated samples were prepared using a Uni-Glatt Fluidized bed coater with a Wurster insert. The coating sprays out from the bottom and maintains a constant flowing pattern. By monitoring weight of solution used, one can control the amount applied, thereby controlling the average thickness of the coating. Parameters employed are indicated in each of the following examples. Formulations were tested for cleaning efficacy on standard stains (including, grass, used motor oil, coffee and dust sebum) using the Model 7243 Tergotometer, using ASTM Method No. D-4265, under the following conditions (unless otherwise specified). A total of eight swatches were used per Tergotometer bucket. Of these, two were used per stain, and two clean bulking swatches were used. The Tergotometer was run at room temperature, and at 50° C., at 100 rpm. The wash cycle was 10 minutes, and the rinse cycle was 2 minutes. Volumes of wash water and rinse water were 1 liter for each. Water used had 6 g/g water hardness. Swatches were evaluated using a BYK-Gardner TCS, Color Sphere Spectrophotometer. Percent detergency was calculated using the formula:

% Det.=[(Rs−Rc)/(Rs−Ro)]*100

where Rs=Soiled reflectance, Rc=Cleaned reflectance, and Ro=Original reflectance of the white swatch. For Examples 1-4, the designated order of release of the different actives is shown in Table 2, and coating materials shown in Table 3.

TABLE 2

| Material | Desired Release Time |
|---|---|
| Surfactant/Chelating Agent/ | slight delay |
| Monoethanolamine/Sodium | |
| Carbonate | |
| Enzyme | slight delay |
| Bleach | moderate delay (about 5 minutes) |
| Bleach Activator | moderate delay (about 5 minutes) |
| Perfume | extended delay (about 12 minutes) |

TABLE 3

| Material | Supplier |
|---|---|
| METHOCEL (HPMC) E6 Premium LV | The Dow Chemical Company |
| PEG (polyethylene glycol) 400 | The Dow Chemical Company |

Coating conditions for each run are shown in the respective sections. Product in the fluid bed was allowed to dry while fluidizing for 30 minutes after the coating application stopped.

TABLE 4

| | |
|---|---|
| Amount of substrate in coater | 599.5 g |
| Amount of solution to spray | 60.0 g |
| Inlet air flap setting | 90 (full open) |
| Inlet air temperature | 60° C. |
| Nozzle air pressure | 2 bar |
| Outlet air temperature | 40° C. |
| Spray rate | 5.9 g/min |
| Actual amount of solution applied | 30.0 g |

After 30 g of liquid was sprayed, the beads clumped together so the run was stopped. The total weight gain was 5%. Sodium carbonate, designated to release after a slight delay, is in a powder form, so it was mixed in with the coated non-pareils prior to coating with HPMC. A ratio of 40% sodium carbonate-60% surfactant/chelating agent/monoethanolamine was used. The coated beads are 5% active so 500 g of coated beads is equal to 25 g actives. The 25 g of actives should be about 60% of the total actives. The total actives were, therefore, 41.6 g, resulting in 16.6 g of sodium carbonate needed. A coating of HPMC E6 and PEG 400 was then applied on the surfactant-coated non-pareil-sodium carbonate mixture to provide the desired delayed release. The coating solution used is shown in Table 5.

TABLE 5

| Wt % | Amount (g) | Material |
|---|---|---|
| 10% | 20 | HPMC E6 |
| 1.7% | 3.3 | PEG 400 |
| 88.3% | 176.7 | DI water |
| 100% | 200 | Total |

Blue (1.1 g) and green (1.1 g) food coloring were added to the solution to help determine coating uniformity. The coating conditions used are in Table 6.

TABLE 6

| | |
|---|---|
| Amount of substrate in coater | 10.4 g |
| Amount of solution to spray | 104.0 g |
| Inlet air flap setting | 90 (full open) |
| Inlet air temperature | 60° C. |
| Nozzle air pressure | 2 bar |
| Outlet air temperature | 40° C. |
| Spray rate | 2.8 g/min |
| Actual amount of solution applied | 104.0 g |

A 2% HPMC E6/PEG 400 weight gain was applied to the materials.

### Example 2

### Enyzme Coating

The enzymes in this embodiment were designated to release after a slight delay. The enzymes and surfactants need to be separated prior to use in a laundry cycle. Two enzyme coating trials were run, each using different enzyme combinations. The enzymes used for the first trial are shown in Table 7. These materials were all obtained from GENENCOR International, Inc. All three materials were mixed together and coated at the same time.

TABLE 7

| Material | Amount |
|---|---|
| Purastar ST 6000E | 86.7 g |
| Purafect 4000E | 87.8 g |
| Puradax HA 400E | 87.5 g |

A 2% HPMC weight gain was desired for the enzymes to release at the required time. The coating formulation used is shown in Table 8.

TABLE 8

| Wt % | Material |
|---|---|
| 10% | HPMC E6 |
| 1.7% | PEG 400 |
| 88.3% | DI water |
| 100% | Total |

Green food coloring was added to look at coating uniformity. The run conditions for this trial are shown in Table 9.

TABLE 9

| | |
|---|---|
| Amount of substrate in coater | 262 g |
| Amount of solution to spray | 52.4 g |
| Inlet air flap setting | 90 (full open) |
| Inlet air temperature | 60° C. |
| Nozzle air pressure | 2 bar |
| Outlet air temperature | 40° C. |
| Spray rate | 8.2 g/min |
| Actual amount of solution applied | 53.3 g |

There were some particle clumps inside the Wurster insert in the coater. The amount of substrate used (262 g) is low for the size of the fluid bed that was used. The particles may have been over-wetted by the coating solution which may have caused them to stick together.

The second enzyme coating run used a combination of two different enzymes, shown in Table 10.

TABLE 10

| Material | Amount | |
|---|---|---|
| Purastar OxAm 4000E | 95.04 | g |
| Properase 4000E | 93.95 | g |
| Total | 188.99 | |

The same coating formulation was used as shown in Table 8. One batch of coating was made and used for both coating trials. The coating conditions are shown in Table 11.

TABLE 11

| | |
|---|---|
| Amount of substrate in coater | 188.9 g |
| Amount of solution to spray | 37.8 g |
| Inlet air flap setting | 90 (full open) |
| Inlet air temperature | 60° C. |
| Nozzle air pressure | 2 bar |
| Outlet air temperature | 38° C. |
| Spray rate | 5.1 g/min |
| Actual amount of solution applied | 37.9 g |

There were a few clumps of particles in the Wurster insert of the coater after the run was complete.

### Example 3

### Bleach Coating

The bleaching agent in this example is sodium percarbonate, which is a granular material so the coating was applied directly to the material. The sodium percarbonate was designated release in the laundry cycle after five minutes, i.e., a moderate delay. The coating formulation used is shown in Table 12.

TABLE 12

| Wt % | Amount (g) | Material |
|---|---|---|
| 10% | 49 | HPMC E6 |
| 1.7% | 8.1 | PEG 400 |
| 88.3% | 432.9 | DI water |
| 100% | 490 | Total |

Blue food coloring (2.02 g) was added to the formulation in Table 12 to help determine coating uniformity on the sodium percarbonate granules. A 5 wt % gain of HPMC E6 was desired to achieve this release time. The coating conditions used are shown in Table 13.

TABLE 13

| | |
|---|---|
| Amount of substrate in coater | 608.1 g |
| Amount of solution to spray | 304 g |
| Inlet air flap setting | 90 (full open) |
| Inlet air temperature | 60° C. |
| Nozzle air pressure | 2 bar |
| Outlet air temperature | 30° C. |
| Spray rate | 7.6 g/min |
| Actual amount of solution applied | 304 g |

Some sodium percarbonate may have been lost when transferring to the coater or may have been caught in the filters. The 5% HPMC E6 weight gain is approximate.

### Example 4

### Bleach Activator Coating

The bleach activator, Warwick B-610 (tetraacetylethylenediamine) was designated to release after five minutes in a laundry cycle. The bleach activator was separated from the bleach to reduce or avoid interaction prior to use in a laundry cycle. The coating formulation used is shown in Table 14.

TABLE 14

| Wt % | Amount (g) | Material |
|---|---|---|
| 10% | 39 | HPMC E6 |
| 1.6% | 6.4 | PEG 400 |
| 88.4% | 344.6 | DI water |
| 100% | 390 | Total |

Red food coloring (2.0 g) was added to the formulation in Table 14 to help determine coating uniformity on the bleach activator. A 5 wt % gain of HPMC E6 was desired to release the bleach activator after five minutes. The coating conditions are shown in Table 15.

TABLE 15

| | |
|---|---|
| Amount of substrate in coater | 370.9 g |
| Amount of solution to spray | 185.5 g |
| Inlet air flap setting | 90 (full open) |
| Inlet air temperature | 68° C. |
| Nozzle air pressure | 2 bar |
| Outlet air temperature | 33° C. |
| Spray rate | 8.0 g/min |
| Actual amount of solution applied | 185.6 g |

A quantity of product was caught in filter bags so the actual weight gain may not be 5%.

### Example 5

### Perfume Coating

An extended delayed release coating was provided on a perfume (fragrance) used in laundry formulations. The perfume was designated to release into the laundry cycle after twelve minutes. The perfume was in liquid form so the first step was to coat the liquid on a solid substrate. Non-pareils (sugar spheres—30-35 mesh) from Paular, were used as the substrate. An “outdoor” scented perfume was sprayed on the non-pareils “as-is,” without any dilutions or other materials added. The coating conditions are shown in Table 16.

TABLE 16

| | |
|---|---|
| Amount of substrate in coater | 669.7 g |
| Amount of solution to spray | 13.4 g |
| Inlet air flap setting | 90 (full open) |
| Inlet air temperature | 50° C. |
| Nozzle air pressure | 2 bar |
| Outlet air temperature | 30° C. |
| Spray rate | 4.9 g/min |
| Actual amount of solution applied | 13.4 g |

A 2% weight gain of perfume was applied to the non-pareil substrate. The inlet air temperature was set lower than the HPMC coating trials to avoid evaporation of the perfume before it was applied to the substrate. The next step was to apply a HPMC E6 coating on the perfume coated non-pareils to delay the release. The coating formulation used is shown in Table 17.

TABLE 17

| Wt % | Amount (g) | Material |
|---|---|---|
| 10% | 80 | HPMC E6 |
| 1.6% | 12.8 | PEG 400 |
| 88.4% | 707.2 | DI water |
| 100% | 800 | Total |

To help determine uniformity of the coating, 1.1 g of blue food coloring and 1.1 g of red food coloring were added to the coating solution. The coating run conditions are shown in Table 18.

TABLE 18

| | |
|---|---|
| Amount of substrate in coater | 666.0 g |
| Amount of solution to spray | 666.0 g |
| Inlet air flap setting | 90 (full open) |
| Inlet air temperature | 60° C. |
| Nozzle air pressure | 2 bar |
| Outlet air temperature | 30° C. |
| Spray rate | 4.8 g/min |
| Actual amount of solution applied | 533.0 g |

After 445 g of solution was applied, the product in the fluid bed stopped moving. The pump was turned off and the material allowed to dry while moving in the fluid bed. The spray was started again and then stopped after a total of 477 g of solution was applied. After a five minute drying time, the pump was started again. After a total of 505 g of solution was applied, the pump was stopped for another five minutes. The pump was re-started and a total of 533 g of solution was applied. The run was stopped at this point, with a total actual weight gain of 8%.

### Example 6

### Cleaning Effectiveness

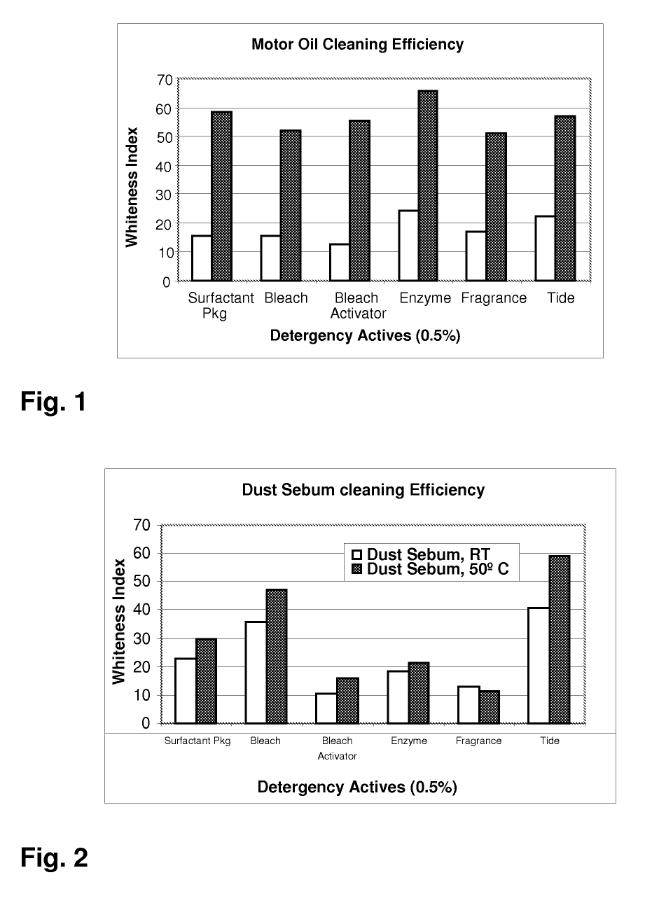

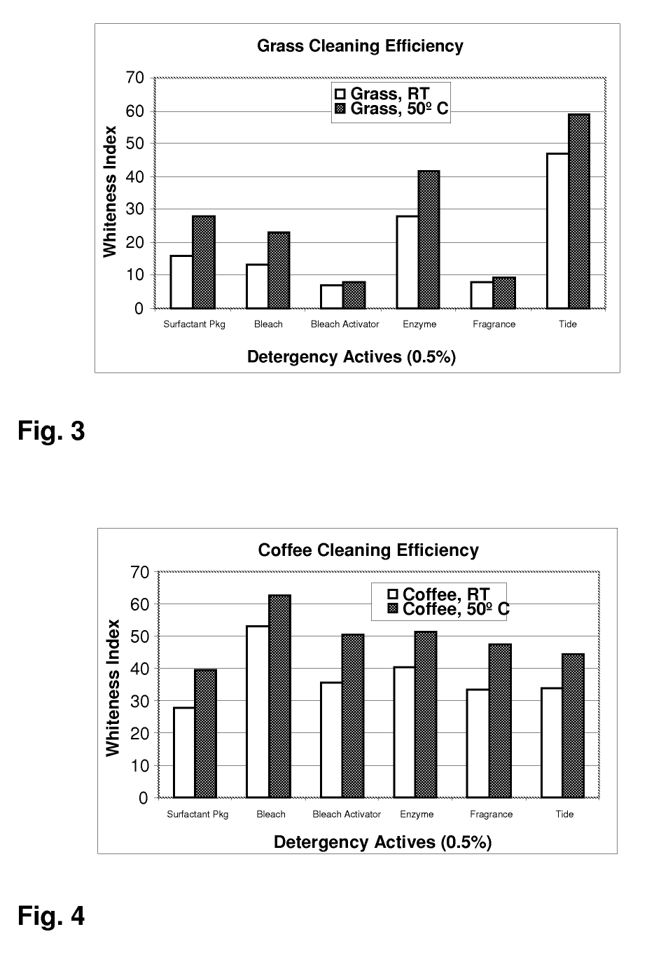

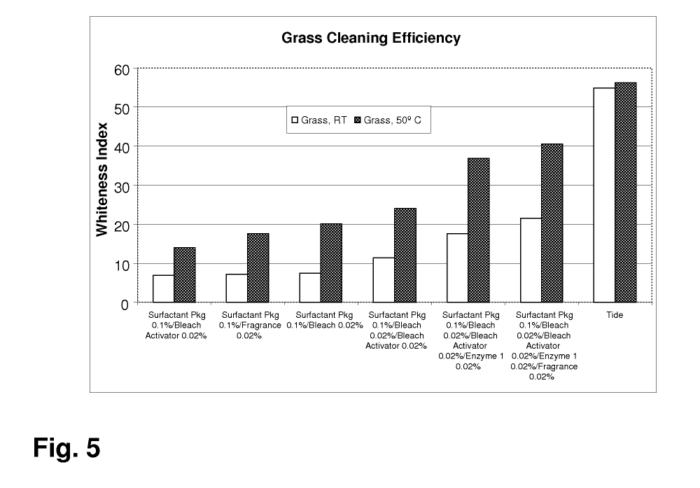

Each encapsulated active of Examples 1-5 was tested in the Tergotometer to measure its effectiveness in removing used motor oil, dust sebum, grass, and coffee at room temperature and 50° C. (FIGS. 1-4). Each active was used at an addition rate of 0.5% actives by weight of wash water. The commercially available product TIDE® was used as the benchmark for the testing performance. This individual testing of actives shows that the encapsulation does not destroy the cleaning activity of the actives. The actives are apparently being released, and are released in time to remove the stains to varying degrees.

It is understood that the present invention is not limited to the embodiments specifically disclosed and exemplified herein. Various modifications of the invention will be apparent to those skilled in the art. Such changes and modifications may be made without departing from the scope of the appended claims.

Moreover, each recited range includes all combinations and subcombinations of ranges, as well as specific numerals contained therein. Additionally, the disclosures of each patent, patent application, and publication cited or described in this document are hereby incorporated herein by reference, in their entireties.

1. A cleaning composition, comprising:
at least two particles, each particle comprising at least one active agent, wherein the at least two particles are adapted to release active agent at different delay release times when the cleaning composition is combined with an aqueous phase, and said particles being encapsulated with water soluble cellulose coating,
and wherein at least one particle i) comprises at least one surfactant, and ii) has a release time providing a slight delay upon combining with the aqueous phase.

2. (canceled)

3. The cleaning composition of claim 1, wherein at least one particle i) comprises at least one bleaching agent, and ii) has a release time providing a moderate delay upon combining with the aqueous phase.

4. The cleaning composition of claim 3, comprising at least one bleach activator.

5. The cleaning composition of claim 1, wherein at least one particle i) comprises at least one perfume or at least one fabric softener, and ii) has a release time providing an extended delay upon combining with the aqueous phase.

6. The cleaning composition of claim 1, wherein the cleaning composition is hot melt exruded.

7. A method for manufacturing the cleaning composition of claim 1, comprising:
manufacturing the first particle and the second particle each with a core, the respective cores being coated with different amounts or different thicknesses of cellulosic polymer, such that the particles are adapted to release the active agents at different release times when the cleaning composition is combined with the aqueous phase.

8. The method of claim 7, further comprising, hot-melt extruding the cleaning composition to produce an extruded cleaning composition.

9. The method of claim 7, further comprising providing that the particles are of different sizes.
